(19) United States
(12) Patent Application Publication
(10) Pub. No.: US 2023/0334764 A1
(43) Pub. Date: Oct. 19, 2023

(54) METHOD AND APPARATUS WITH IMAGE PROCESSING

(71) Applicants: Samsung Electronics Co., Ltd., Suwon-si (KR); Korea Advanced Institute of Science and Technology, Daejeon (KR)

(72) Inventors: Heesae LEE, Ansan-si (KR); Kyubeom HAN, Daejeon (KR); Jaeyoon KIM, Daejeon (KR); Sung-Eui YOON, Daejeon (KR); Seeha LEE, Daejeon (KR); Inwoo HA, Seongnam-si (KR)

(73) Assignees: Samsung Electronics Co., Ltd., Suwon-si (KR); Korea Advanced Institute of Science and Technology, Daejeon (KR)

(21) Appl. No.: 18/193,769

(22) Filed: Mar. 31, 2023

(30) Foreign Application Priority Data
Apr. 19, 2022 (KR) 10-2022-0048348

(51) Int. Cl. G06T 15/10; G06T 15/08; G06T 15/06; G06T 7/60; G06T 7/73; G06T 9/00; H04N 23/698

(52) U.S. Cl. CPC G06T 15/10; G06T 15/08; G06T 15/06; G06T 7/60; G06T 7/73; G06T 9/00; H04N 23/698; G06T 2207/20084; G06T 2207/20081

(57) ABSTRACT

A method and apparatus with image processing are provided. A method includes determining sample points sampled on a camera ray, wherein the camera ray is based on view-generation information comprising a scene viewing-position and a scene-viewing direction, determining location statuses of the respective sample points based on a virtual cylindrical coordinate system defined by a center and a radius, projecting and rendering a value of a pixel corresponding to the camera ray by, according the location statuses, applying the view-generation information to a first neural network to generate a first rendering result and to a second neural network to generate a second rendering result, wherein the first neural network has been trained to generate foreground images and the second neural network has been trained to generate background images, and generating a rendered image based on blending the first rendering result and the second rendering result.

### CROSS-REFERENCE TO RELATED APPLICATIONS

This application claims the benefit under 35 USC § 119(a) of Korean Patent Application No. 10-2022-0048348, filed on Apr. 19, 2022, at the Korean Intellectual Property Office, the entire disclosure of which is incorporated herein by reference for all purposes.

### BACKGROUND

### 1 Field

The following description relates to a method and apparatus with image processing.

### 2. Description of Related Art

A 360-degree camera system may capture and/or provide an omnidirectional image with, for example, a 360-degree horizontal and 180-degree vertical view angle, with which a virtual reality may be provided. A 360-degree image captured by a 360-degree camera system may be used to generate views, of various angles, of a 3D space. For example, a new view may be synthesized by various captured images, such as a 360-degree image and/or a front image of a scene with a boundary.

### SUMMARY

This summary is provided to introduce a selection of concepts in a simplified form that are further described below in the Detailed Description. This summary is not intended to identify key features or essential features of the claimed subject matter, nor is it intended to be used as an aid in deciding the scope of the claimed subject matter.

In one general aspect, a method includes determining sample points sampled on a camera ray, wherein the camera ray is based on view-generation information comprising a scene viewing-position and a scene-viewing direction, determining location statuses of the respective sample points based on a virtual cylindrical coordinate system defined by a center and a radius, projecting and rendering a value of a pixel corresponding to the camera ray by, according the location statuses, applying the view-generation information to a first neural network to generate a first rendering result and to a second neural network to generate a second rendering result, wherein the first neural network has been trained to generate foreground images and the second neural network has been trained to generate background images, and generating a rendered image based on blending the first rendering result and the second rendering result.

The determining of the location statuses of the respective sample points may include computing distances between the center and each of the plurality of points, respectively, and comparing the distances with the radius, and determining whether the location status of a corresponding sample point among the plurality of sample points may be foreground or background based on the comparing.

The determining of whether the location status of a corresponding sample point is foreground or background may be based on the comparing may include determining the location status of a corresponding sample point as foreground based on the corresponding distance being smaller than the radius, and determining the location of a corresponding sample point as background may be based on the corresponding distance being greater than or equal to the radius.

The rendering may include applying the view-generation information to the first neural network in response to a location status of a corresponding sample point being determined to be foreground.

The rendering may include, based on a location status of a corresponding sample point being determined to be background, changing the view-generation information to comprise the inverse of the radius, and applying the changed view-generation information to the second neural network.

The first neural network may be a neural network trained to output a color and volume density of a pixel associated with a corresponding point in a foreground image based on receiving the view-generation information encoded based on the virtual cylindrical coordinate system.

The second neural network may be a neural network trained to output a color and volume density of a pixel associated with a corresponding point in a background image based on receiving the changed view-generation information encoded based on the virtual cylindrical coordinate system.

The rendering may include projecting and rendering a color and volume density of a pixel decided for each location status of the respective sample points.

In one general aspect, a method includes estimating pose information corresponding to at least one object included in each of respective image frames of an input image captured by a 360-degree camera, encoding location statuses of respective points sampled for each of camera rays formed based on the pose information, based on a virtual cylindrical coordinate system defined by a center and a radius, adding and rendering pixel values obtained by determining which of a first neural network or a second neural network to apply the encoded points to based on the location statuses, wherein the first neural network may be configured to generate a foreground image and the second neural network may be may be configured to generate a background image, and training the first neural network and the second neural network based on a pixel value of a camera ray, the pixel value obtained by blending the rendering result for each of the camera rays.

The encoding may include estimating first pose information corresponding to at least a first object and a second object included in each of the image frames, separating and encoding points corresponding to the first object as foreground based on a direction from which the 360-degree camera views the first object being inside a virtual cylinder corresponding to the virtual cylindrical coordinate system, and separating and encoding points corresponding to the second object as background based on being outside the virtual cylinder, based on the virtual cylindrical coordinate system.

The encoding may include determining the location statuses of the respective points sampled for each of the camera rays as either foreground or background, based on the virtual cylindrical coordinate system, and based on the determining of the location statuses, encoding each location status of the respective points.

The determining the location statuses of the respective points as foreground or background may include for each of the camera rays, computing distances between the center and the respectively corresponding points, and comparing the distances with the radius, and for each of the camera rays, determining the location statuses of the respectively corresponding points as foreground or background based on results of the comparing.

The determining of the location statuses of the points as foreground or background may include determining the location status of a corresponding point as foreground based on the corresponding distance being less than the radius, and determining the location status of a corresponding point as background based on the corresponding distance being greater than or equal to the radius.

The rendering may include at least one of first rendering by the first neural network according to the location status of a corresponding point being foreground, or second rendering by the second neural network according to the location status of a corresponding point being background.

The training further may include training the first neural network and the second neural network based on a difference between a pixel value generated by blending a result of the first rendering and a result of the second rendering.

A non-transitory computer-readable storage medium storing instructions that, when executed by a processor, cause the processor to perform the method of claim 9.

In one general aspect, an apparatus includes processing hardware, storage hardware storing instructions configured to configure the processing hardware to: sample points on a camera ray formed based on view-generation information may further include a position and direction of a view of a scene, determine location statuses of the points based on a virtual cylindrical coordinate system defined by a center and a radius, determine a pixel value by, for each point, according to the location status thereof, select between applying a first neural network trained to generate a foreground image and a second neural network trained to generate a background image, and project and render the determined pixel value.

The apparatus may further include rendering an image based on blending a result of applying the first neural network and the second neural network.

The instructions may be further configured to configure the processing hardware to compare distances between the center and the respective points with the radius, and based thereon determine whether the location statuses of the points are foreground or background.

The instructions may be further configured to configure the processing hardware to determine the location status of a corresponding point as foreground based the corresponding distance being less than the radius, and the location status of a corresponding point as background based on the corresponding distance being greater than or equal to the radius.

The instructions may be further configured to configure the processing hardware to apply and render the view-generation information to the first neural network based on the location status of a corresponding point being determined to be foreground, and apply and render the view-generation information, as changed to include the inverse of the radius, based on the location status of a corresponding point being determined to be background.

In one general aspect, a method includes projecting camera rays from a virtual camera pose to a scene to determine sample points of the respective camera rays, according to a virtual cylinder and the virtual camera pose, determining first of the sample points as corresponding to a foreground of the scene and based thereon generating respective first pixel values of the scene by applying the virtual camera pose to a first neural network, according to the virtual cylinder and the virtual camera pose, determining second of the sample points as corresponding to a background of the scene and based thereon generating respective second pixel values of the scene by applying a transform of the virtual camera pose to a second neural network, and rendering an image of the scene by blending the first pixel values and the second pixel values.

Determining that a first sample point of the first sample points may correspond to the foreground may correspond to determining that the first sample point is inside the virtual cylinder, and wherein determining that a second sample point of the second sample points may correspond to the background may correspond to determining that the second sample point is outside the virtual cylinder.

The transform may be based on a radius of a virtual cylinder used to determine the first sample points as corresponding to the foreground and to determine the second sample points as corresponding to the background.

The first neural network and the second neural network may be trained by minimizing a loss function based on a 360-degree image.

Other features and aspects will be apparent from the following detailed description, the drawings, and the claims.

### BRIEF DESCRIPTION OF THE DRAWINGS

FIG. 1 illustrates an example of an image processing method, according to one or more embodiments.

FIG. 2A illustrates an example of a virtual cylindrical coordinate system, according to one or more embodiments.

FIG. 2B illustrates an examples of a virtual cylindrical coordinate system, according to one or more embodiments.

FIG. 3 illustrates an example of a training method for image processing, according to one or more embodiments.

FIG. 4 illustrates an example of a training apparatus for image processing, according to one or more embodiments.

FIG. 5 illustrates an example of an input image, according to one or more embodiments.

FIG. 6 illustrates an example of a configuration of a neural network, according to one or more embodiments.

FIG. 7 illustrates an example of an operation of a first neural network, according to one or more embodiments.

FIG. 8 illustrates an example of an image processing apparatus, according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

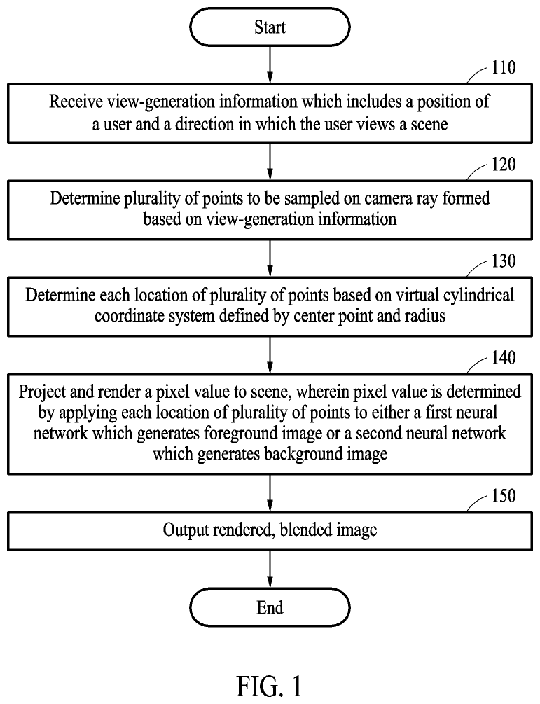

FIG. 1 illustrates an image processing method according to one or more embodiments. In the following examples, operations may be performed sequentially, but are not necessarily performed sequentially. For example, depending on the context, the order of the operations may be changed and at least two of the operations may be performed in parallel.

Referring to FIG. 1, an image processing apparatus according to an example embodiment may output a rendered image via operations 110 to 150.

In operation 110, the image processing apparatus receives view-generation information that includes a viewing position and a viewing direction from which a user views a scene, e.g., the position and direction of a virtual camera for which a corresponding view of the scene is to be generated, i.e., a virtual view. The position of the virtual camera may be expressed as 3D coordinates such as x, y, and z (not to be confused with the external point location mentioned below, also denoted (x,y,z)). The position of the virtual camera corresponds to a position for which the image processing apparatus is to reconstruct an image for the virtual view, and the position may be referred to herein as a scene position (a position within a scene). Also, the direction in which the virtual camera points (which may be mapped to a viewing direction of a person or a sensing device) within the scene corresponds to, for example, a direction in which the image processing apparatus is to reconstruct the image for the virtual view may be referred to as a viewing direction, and may be expressed as d.

In operation 120, the image processing apparatus samples with respective camera rays projected based on the view-generation information. Each camera ray may be modeled as a ray emitted from a center point of a virtual camera to a surface of a 3D scene, and a point sampled for a camera ray is where the camera intersects a surface of a 3D model of the scene corresponding to the 360-degree image.

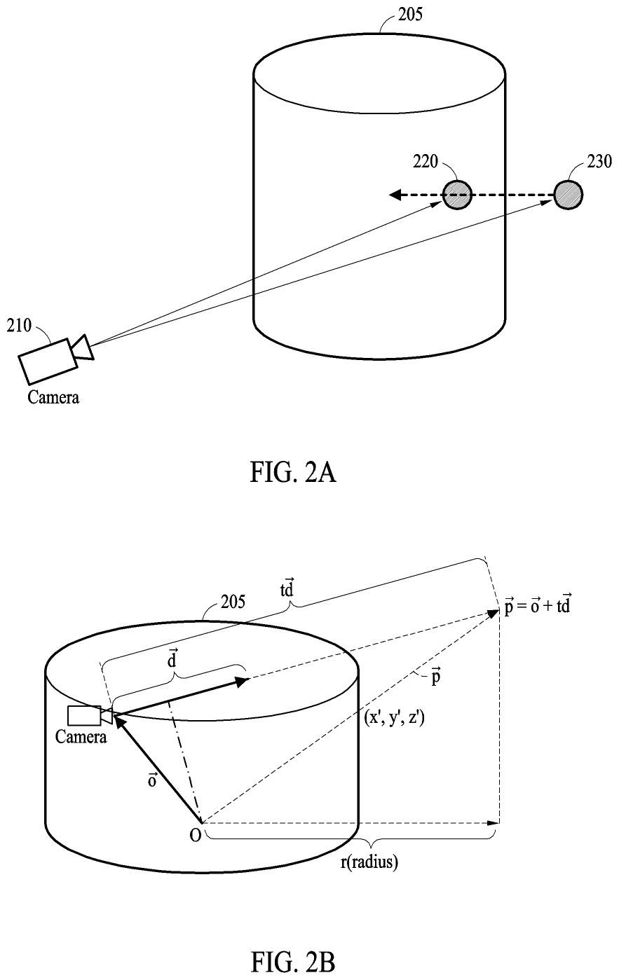

In operation 130, the image processing apparatus decides location statuses (foreground or background) of respective sampled points based on a virtual cylindrical coordinate system which is defined by a center point O and a radius r as shown in FIG. 2B below. The image processing apparatus may, for each point, compare (i) a distance between the center point O the point with (ii) the radius r of the virtual cylinder. For example, as shown in FIG. 2B, the distance of (i) may be the distance of a 2D projection (in the x, y plane) of the vector from O to p. For each sample point, the image processing apparatus may decide whether the location status of the point is foreground or background, based on the comparison result of the sample point's distance (to O) and the radius r. If the distance is less than the radius, the location status of the point is foreground (corresponding to the inside of the virtual cylinder). If the distance is greater than or equal to the radius, the location status of the point is background (corresponding to an outside of the virtual cylinder).

As described above, the process of determining the location statuses of the sampled points based on the virtual cylinder may be referred to as a cylinder parameterization. The virtual cylinder will be described with reference to FIG. 2A, and the cylinder parameterization will be described reference to FIG. 2B.

In operation 140, the image processing apparatus performs rendering by projecting pixel values corresponding to the respective camera rays on the scene. Each camera ray's pixel value is generated (rendered) based on the location status of the camera ray's sampled point. Specifically, whether a pixel value is generated by a first neural network (for generating a foreground image) or a second neural network (for generating a background image) depends on the location status of the corresponding sampled point of the corresponding camera ray. Here, the pixel may be a unit describing a specific point of the scene. The pixel value may include, but is not limited to, for example, an RGB color value, volume density, and/or transparency.

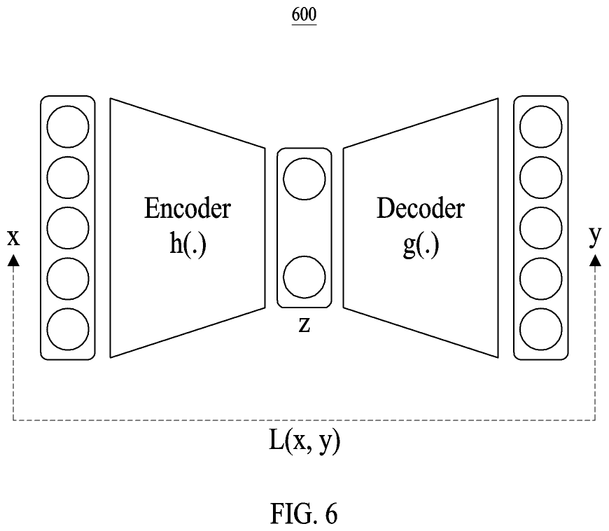

The first neural network may be referred to as a foreground neural network, insofar as it is trained to generate the foreground image. The second neural network may be referred to as a background neural network, insofar as it is trained to generate the background image. As described with reference to FIG. 6, the first neural network and/or the second neural network may include, for example, an auto-encoder, or may include a convolutional neural network including fully connected layers, but is not necessarily limited thereto.

The pixel value corresponding to a camera ray may include, for example, a color and a volume density of a pixel of an image plane (of an image of the scene) intersected by the camera ray but is not necessarily limited thereto.

If the operation 130 decided the location status of a corresponding sample point to be foreground, the image processing apparatus may perform rendering for corresponding camera ray (and sample point) by applying the view-generation information to the first neural network. The first neural network may include, for example, a neural network trained to receive as input a view-generation information (encoded based on the virtual cylindrical coordinate system) and output the color and volume density (for example) of a pixel associated with a corresponding point in the foreground image. However, if the location status of the corresponding sample point was decided to be background, the image processing apparatus may (i) change the view-generation information to include the inverse (1/r) of the radius of the virtual cylindrical coordinate system, and (ii) render the thus-transformed view-generation information (i.e., generate the color and volume density of a pixel associated with a corresponding point in the background image) by inputting it to the second neural network. The second neural network may be trained to receive a view-generation information (e.g., the transformed view-generation information) and output the color and volume density of a pixel related to the corresponding point in the background image.

To elaborate on the changing of the view-generation information to include the inverse (1/r) of the radius, unlike the foreground, the background is highly scalable, so background sample points can have an infinite radius (e.g., r, or depth). These properties can adversely affect the training of deep learning models. In some embodiments, effective learning can be facilitated by replacing this with a parameter of 1/r, which fixes the range between 0 and 1. This technique may obtain high-fidelity by allowing the details of the background to be learned within a set range of parameters.

In operation 140, the image processing apparatus may perform, for example, a volume rendering showing discrete sampling 3D data set in the form of a 3D scalar field (e.g., voxels) in a 2D perspective. In order to perform the volume rendering which projects the 3D data set to 2D, the image processing apparatus may define a color and transparency for all voxels in the 3D data set, while defining a camera for a space in which a volume exists (as used herein, except where “camera” refers to a camera that captures images, “camera” refers to a virtual camera). Such a voxel value may be computed by, for example, an RGBA (red, green, blue, alpha) conversion function. The image processing apparatus may allocate RGBA values to all possible voxels, respectively. The image processing apparatus may perform rendering by repeatedly projecting the color and volume density of a pixel decided for each location status of the sampled points.

In operation 150, the image processing apparatus may output a finally rendered image that is obtained by combining, e.g., by blending, the rendering results of operation 140. Here, the finally rendered image may be an image showing a view corresponding to a scene corresponding to a position and direction of the view of the user, i.e., a virtual camera view.

FIGS. 2A and 2B illustrate a virtual cylindrical coordinate system according to an example embodiment. FIG. 2A illustrates the positional relationship between a first point 220 and a second point 230 viewed by a camera 210 relative to a virtual cylinder 205 corresponding to the virtual cylindrical coordinate system.

The image processing apparatus may decide that an object corresponding to the first point 220 is a foreground object if the position and direction of the first point 220 (from which the camera 210 views the scene) is inside the cylinder 205 corresponding to the virtual cylindrical coordinate system. The image processing apparatus may decide that an object corresponding to the second point 230 is a background object if the position and direction of the second point 230 (from which the camera 210 views the scene) is outside the cylinder 205 corresponding to the virtual cylindrical coordinate system.

The virtual cylindrical coordinate system may be a 3D spatial coordinate system which composes a space occupied by at least one object with a horizontal space of the x-axis and y-axis.

FIG. 2B illustrates a cylinder parameterization process according to an example embodiment.

The image processing apparatus may treat a scene space as being divided into an internal volume (corresponding to the inside of the virtual cylinder 205) and an outer volume (corresponding to the outside of the virtual cylinder 205). Here, the internal volume may include a foreground space and all virtual cameras (possible viewpoints), and the external volume may include a background space corresponding to the remaining parts except for the foreground space (initially, a cylinder may be set to contain all of the virtual cameras, thus, the interior of the cylinder can be defined as the foreground, and points outside the cylinder can be defined as the background). The foreground and the background may be modeled by respective neural networks (e.g., the first neural network and the second neural network). The image processing apparatus may project individual camera rays to render the colors of the camera rays, and then perform final synthesizing (i.e., combining results of both neural networks).

Since a boundary of a foreground part of a scene is clearly distinguished, re-parameterization in association therewith is not necessary, so the foreground image may be modeled and rendered by applying the view-generation information directly to the first neural network. In contrast, since the boundary of a background part of a scene may not be clearly distinguished, the image processing apparatus may model and render the background image by mapping the view-generation information to a surface of the virtual cylinder 205 and then apply the thus-changed view-generation information to the second neural network.

More specifically, the image processing apparatus may change (map) a 3D point (x, y, z) in the external volume to a point (or location) (x′, y′, z′, 1/r) on the surface of the virtual cylinder 205. Here, (x′, y′, z′) may be a unit vector in the direction of (x, y, z) from the center O of the virtual cylinder 205. 0<1/r<1 may represent a point r·(x′, y′, z′) outside the cylinder following the direction of the virtual cylinder 205.

Unlike in Euclidean space where an object may be at an unlimited distance from an origin, the image processing device can designate the boundary of an object by four parameterized values (x′, y′, z′, 1/r). Accordingly, modeling may be performed so that a faraway object has a lower resolution. The image processing apparatus may render a color of a camera ray by directly raycasting a ray corresponding to (x′, y′, z′, 1/r).

For example, a camera ray \vec{p}=\vec{o}+t\vec{d} may be divided into two parts, which are an inner volume corresponding to the inside of the virtual cylinder 205 and an outer volume corresponding to the outside of the virtual cylinder 205, by the virtual cylinder 205. For example, t∈(0,t′) may correspond to the inside of the virtual cylinder 205, and t∈(t′,∞) may correspond to the outside of the virtual cylinder 205.

Here, \vec{o} may correspond to a vector indicating a relationship between a location of the camera ray and the center point O, and \vec{d} may correspond to a vector indicating the viewing direction d.

The 3D point (x, y, z) of the external volume is projected on the pixel (x′, y′, z′) of the surface of the virtual cylinder 205, and 1/r∈(0, 1) may act as the disparity of the point (e.g., displacement from the original location to the location on the cylinder volume or from the central longitudinal axis of the cylinder).

The image processing apparatus according to an embodiment may improve the image quality of each of the separated foreground and background by using the cylindrical coordinate system, while also reducing the amount of memory used.

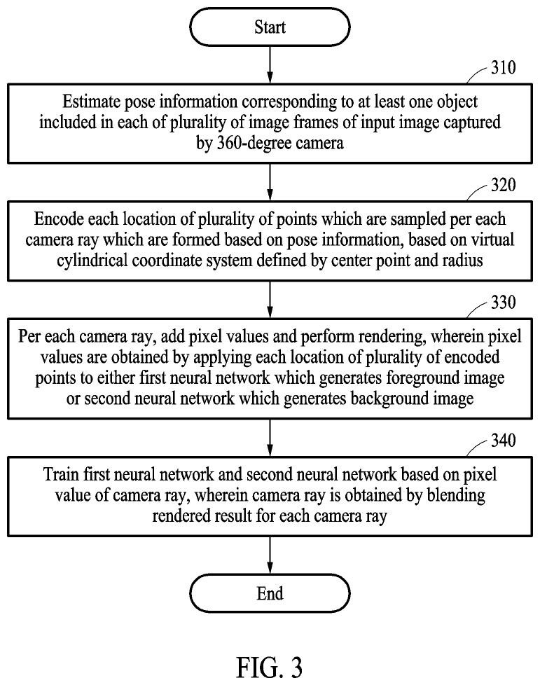

FIG. 3 illustrates an example of a training method for image processing according to an example embodiment. In the following examples, operations may be performed sequentially, but are not necessarily performed sequentially. For example, the order of the operations may be changed and at least two of the operations may be performed in parallel.

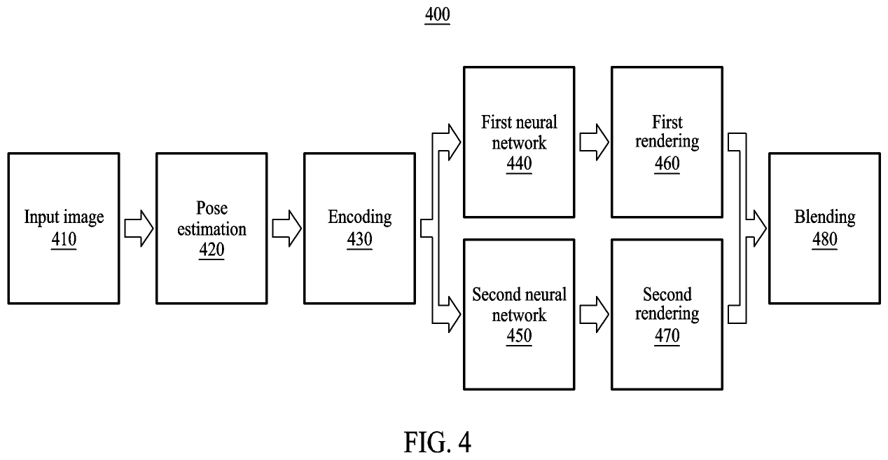

Referring to FIG. 4, a training apparatus according to an example embodiment may train the first neural network and the second neural network via operations 310 to 340.

In operation 310, the training apparatus estimates pose information of an object based on a set of image frames that include the object (the pose information may be, e.g., 3D location, a 3D reconstructed wireframe model of the object, a set of voxels, a combination of both, or other forms). The image frames may be frames of an input image captured by a 360-degree camera-. The images frames may be derived from a complete 360-degree image, or they may be images that collectively form a 360-degree image/view. The training apparatus may estimate the pose information of the object from the image frames by using photogrammetry on the image frames, for example, using the Source Filmmaker (SFM) framework implementing the COLMAP image processing pipeline. The photogrammetry reconstructs a dense 3D point cloud based on 3D camera directions and locations respectively corresponding to the image frames (which may be tracked when the image frames are captured). The dense 3D point cloud represents actual points in a 3D space and captures a surface of the at least one object. The 3D points may include image data (e.g., voxel values) derived from pixels of the image frames during the photogrammetry. In some embodiments, the photogrammetry may be performed directly on multiple 360-degree images (using an algorithm specific thereto) rather than frames/portions thereof.

In operation 320, the training apparatus encodes the location of each of the plurality of points sampled for each respective camera ray formed based on the pose information (multiple camera rays are projected from the pose location, and each camera ray has a respective plurality of points sampled), based on the virtual cylindrical coordinate system defined by the center point and the radius. The training device is, for example, based on the virtual cylindrical coordinate system, if the direction in which the 360-degree camera views at least one object is inside the virtual cylinder corresponding to the virtual cylindrical coordinate system (sub-360-degree, i.e., semi-circular images/cameras may also be used), the points corresponding to at least one object may be encoded by being separated into the foreground. Unlike the foregoing, if the object is outside the virtual cylinder (in the direction viewed by the 360-degree camera views), the points corresponding to at least one object may be encoded by being separated into the background. In some embodiments, some camera rays have sampled points that correspond to the object, and such sampled points have their status set to background or the foreground based on whether the object itself (e.g., a center of mass thereof) is determined to be inside or outside the virtual cylinder.

For some ray-sampled points (e.g., other than points corresponding to the object), the training apparatus may decide the respective location statuses thereof based on the virtual cylindrical coordinate system. For a given camera ray (representative of the processing performed for multiple camera rays), the training apparatus may compute distances of respective points (on the given camera ray) to the center point (O) of the virtual cylinder (see the description of FIGS. 2A and 2B), and may compare each of the distances with the radius of the virtual cylinder. Based on a result of the comparisons between the distances and the radius, the training apparatus may decide, for each point of the given camera ray), whether the status thereof is set to foreground or background. If the distance of a point to O (or a central longitudinal axis through O) is less than the radius, the training apparatus may decide that the location status of the point is foreground (corresponding to the inside of the virtual cylindrical coordinate system). If the distance of a point is greater than or equal to the radius, the training apparatus may decide that the location status of the point is background (corresponding to the outside of the virtual cylindrical coordinate system).

Criterion for determining whether the foreground-background status of a sampled point on a camera ray is either the foreground or the background may be decided by, for example, determining an image quality obtained by training of the training apparatus using a loss function. The training apparatus may encode locations of the plurality of points based on decisions that the location statuses of each of a ray's sample points is foreground or background.

In operation 330, the training apparatus sums and renders the pixel values obtained by applying the location of each of the plurality of encoded points to either the first neural network generating the foreground image or the second neural network generating the background image for each camera ray. For example, if the location status of a corresponding point is decided as foreground, the training apparatus may perform a first rendering by applying the location of the corresponding point to the first neural network. If the location status of a corresponding point is decided as background, the training apparatus may perform a second rendering by applying the result of changing the location (e.g., 1/r) of a corresponding point to the second neural network.

Regarding the sum noted directly above, note that the final pixel value can be based on the RGB value and volume density of each sample point (which can be obtained by the encoder-decoder). As shown in Equation 1 below, the sum (final pixel value) may be obtained by using the weighted sum method of estimating the weight based on the volume density and multiplying by the RGB value.

$$\hat{C} ( r ) = {\sum }_{i = 1}^{N} {T}_{i} ( 1 - exp ( - {σ}_{i} {δ}_{i} ) ) {c}_{i} , \qquad Equation 1$$

$$where {T}_{i} = exp ( - {\sum }_{j = 1}^{i - 1} {σ}_{j} {δ}_{j} ) ,$$

Here, C(r) is the RGB of the final pixel, and c_i is the RGB of sample point i. σ_i is the volume density of sample point i, and δ_i is the distance between sample point i and i+1.

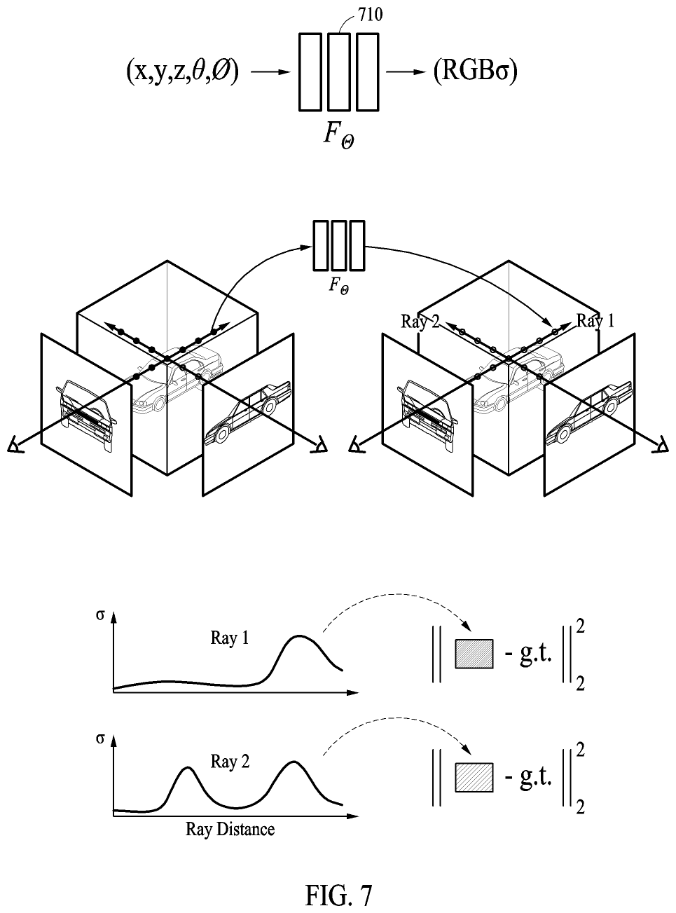

In operation 340, the training apparatus trains the first neural network and the second neural network based on the pixel values of the respectively corresponding camera rays obtained by blending the rendering result of operation 330 of each corresponding camera ray. The training apparatus may train the first neural network and the second neural network based on a difference between (i) a pixel value of the corresponding camera ray (obtained by blending the first rendering result and the second rendering result) and (ii) a pixel value corresponding to the camera ray in the input image (e.g., a ground truth pixel value). The training apparatus may train the first neural network and the second neural network to minimize the difference between the rendered/synthesized pixel value of the corresponding camera ray and the input image pixel value corresponding to the camera ray. A method for the training apparatus to train the first neural network and/or the second neural network is described with reference to FIGS. 6 to 7.

FIG. 4 illustrates an operating process of a training apparatus for image processing according to an example embodiment. Referring to FIG. 4, a training apparatus according to an example embodiment may train the first neural network and the second neural network via operations 410 through 480.

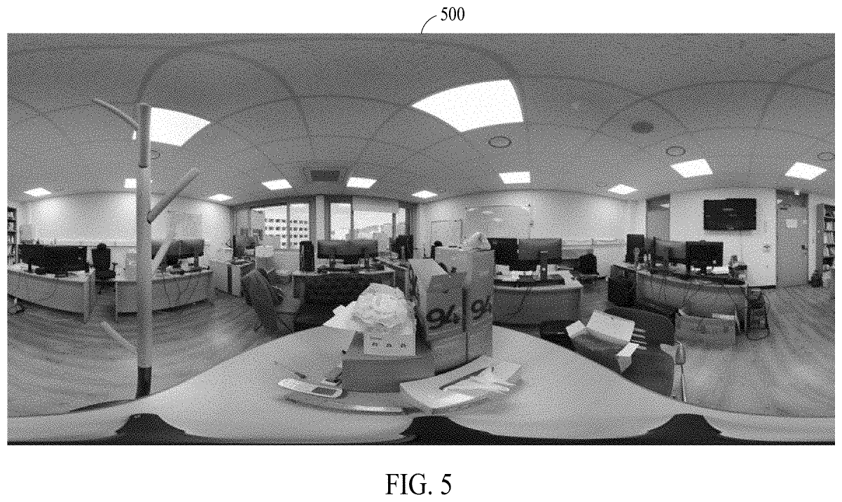

In operation 410, the training apparatus may receive an input image. The input image may be, for example, a 360-degree captured image of bounded scenes captured by a 360-degree camera (as shown in FIG. 5 below) or a forward-facing capture unassociated with a boundary, but is not necessarily limited to these examples.

In operation 420, the training apparatus may estimate poses of objects included in the input image. The training apparatus may estimate poses of objects included in each of image frames included in the input image.

In operation 430, the training apparatus may encode the poses of the objects based on the virtual cylindrical coordinate system. The training apparatus may encode the poses of the objects estimated in operation 420 with parameters based on a virtual cylindrical coordinate system. The process of encoding the poses of objects into parameters based on the virtual cylindrical coordinate system may be the cylinder parameterization process described above. The objects are separated into a foreground and a background through the cylinder parameterization process of the estimated poses of the objects. Here, the parameters based on the virtual cylindrical coordinate system may be learned through the training process performed in operation 480.

In one example embodiment, by separating the foreground and the background, and by performing training and/or rendering on each of the foreground and the background, the resolution may be improved for both near and distant pixels by applying different resolutions for scenes, for objects, and/or for the foreground/background, and image processing efficiency may be improved.

In operation 430, if an encoded parameter corresponds to the inside of the cylinder (of the virtual cylindrical coordinate system), the training apparatus may determine that the object corresponding to the parameter corresponds to the foreground. If the encoded parameter corresponds to the outside of the cylinder, the training apparatus may determine that the object corresponding to the parameter corresponds to the background.

In operation 440, the training apparatus may render a first result of applying the parameter of an object determined to correspond to the foreground to the first neural network as in operation 460.

In operation 450, the training apparatus may render a result of applying the parameter of an object decided to correspond to the background to the second neural network as in operation 470.

In operation 480, the training apparatus may train the first neural network and the second neural network based on a value obtained by blending the first rendering result of operation 460 and the second rendering result of operation 470.

FIG. 5 illustrates an example of an input image according to an example embodiment. FIG. 5 illustrates a 360-degree image 500 captured by a 360-degree camera, which is an example of an input image according to an example embodiment.

FIG. 6 illustrates a configuration of a neural network according to an example embodiment. FIG. 6 illustrates a structure of a neural network according to an example embodiment.

The first neural network and the second neural network, according to an example embodiment, may each include a respective autoencoder 600 including an encoder and a decoder, but is not limited thereto.

The sizes of input layer x and an output layer y of the autoencoder 600 may be x,y∈ [symbol] ^{d}. The autoencoder 600 may have other layers, e.g., either may have one or more hidden layers.

The encoder part of the autoencoder 600 may convert the original image (or corresponding input vector) applied to the input layer x into a latent vector z of a latent space. The latent space may be a space in which latent features of the original image are represented in a low-dimension vector. The latent vector z may be expressed as

z=h(x)∈ [symbol] ^{d}^{_{z}}

The decoder part of the autoencoder 600 may output an output vector (or image) reconstructed from the latent vector z through the output layer y. The output layer y may be expressed as y=g(z)=g(h(x)).

A loss LAE(x,y) of the autoencoder 600 may correspond to a difference between input data and reconstructed data. The loss of the autoencoder 600 can be calculated by

L_{AE}=Σ_{x∈D}L(x,y).

The training apparatus may train the autoencoder 600 to minimize loss LAE(x,y) of the autoencoder 600, which corresponds to a difference between the output vectors of the output layer y corresponding to the and their respective input vectors of the input layer x.

FIG. 7 illustrates an operation of a first neural network 710, according to one or more embodiments.

The first neural network 710 may be, for example, a fully-connected deep neural network, but is not limited thereto.

The first neural network 710 may receive, for example, 5D coordinates including spatial positions x, y, z and viewing directions θ, φ (e.g., altitude and azimuth). Here, the spatial positions x, y, z may correspond to a location of a world coordinate system that is normalized based on the coordinates of the camera (i.e., the world coordinate system is a frame of reference or coordinate system corresponding to the real world and camera coordinates therein relate to positions of the camera to the real world).

The first neural network 710 may be a neural network trained to output pixel values (e.g., RGB colors and/or volume densities) σ of pixels for respective 5D coordinates in the foreground image that are inputted to the first neural network 710. A volume density σ may indicate a contribution of a corresponding pixel. For example, a high volume density value may indicate that the contribution of the corresponding pixel is high, and a low volume density value may indicate that the contribution of the corresponding pixel is low.

The first neural network 710 may query the 5D coordinates/points along the camera rays, e.g., ray 1 and/or ray 2, and may synthesize views by projecting the output pixel values on an image (or view) using a volume rendering technique. Here, since the volume rendering technique is naturally differentiable, the first neural network 710 may be trained using an image set (having known camera poses) for optimizing views as an input. That is, the image set may include a ground truth g pixel value corresponding to known camera poses.

The training device may train the first neural network 710 so that the difference between a result value from the first neural network 710 and a ground truth pixel value is minimized. The result value may be an accumulation of a plurality of pixel values corresponding to a plurality of points sampled in the camera ray until a point of the camera ray, such as ray 1 and/or ray 2, reaches a certain point of an image plane (as implied by sufficient reduction of the difference/loss). Such points sampled in the camera ray are indicated in FIG. 7 by dots/nodes on the rays.

The second neural network may operate similarly to the first neural network 710 except that in the second neural network an input thereto, (x, y, z), is obtained/transformed by adding the inverse 1/r of the radius of the virtual cylindrical coordinate system, as described above.

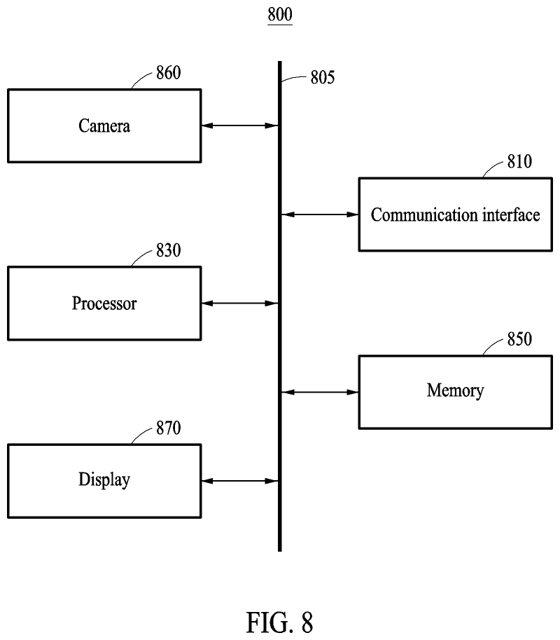

FIG. 8 illustrates an image processing apparatus according to an example embodiment. Referring to FIG. 8, an image processing apparatus 800 may include a communication interface 810, a processor 830, a memory 850, a camera 860, and a display 870. The communication interface 810, the processor 830, and the memory 850 may be connected by a communication bus 805.

The communication interface 810 receives view creation information including a position and direction from which a user views a scene. The display 870 may display graphics rendered as described herein, which may be based on image(s) captured by the camera 860. Although 360-degree images and cameras are mentioned above, the techniques described herein may be used with other types of cameras and images; 360-degree cameras/images are not required.

The processor 830 decides the plurality of points to sample on the camera ray formed based on the view generation information. The processor 830 decides location statuses of the plurality of points based on a virtual cylindrical coordinate system defined by a center point and a radius. The processor 830 projects and renders the ray's pixel value for the scene, wherein the pixel value is decided by applying the corresponding point to either the first neural network which generates a foreground image or the second neural network which generates a background image for each location of the plurality of points. The processor 830 generates a rendered image obtained by blending the rendering results for the camera ray (the step may be performed for each of multiple camera rays).

The processor 830 may compare distances between the center point of the virtual cylindrical coordinate system and each of the plurality of points with the radius of the virtual cylindrical coordinate system. The processor 830 may decide whether the location of a corresponding point among a plurality of points belongs to the foreground or the background based on the comparison result. For example, if the distance of a point is less than the radius, the processor 830 may determine the location status of the corresponding point as being the foreground, i.e., corresponding to the inside of the virtual cylindrical coordinate system. If the distance is greater than or equal to the radius, the processor 830 may decide the location status of a corresponding point as being the background, i.e., corresponding to the outside of the virtual cylindrical coordinate system.

If the location status of a corresponding point is determined to be foreground, the processor 830 may render the view by applying the view-generation information to the first neural network. If the location status of a corresponding point is determined as the background, the processor 830 may render the view by applying the view-generation information, as changed to include, for example, the inverse of the radius of the virtual cylindrical coordinate system, to the second neural network.

Also, the processor 830 may execute a program (in the form of machine-executable instructions, source code, bytecode, and/or the like) and control the image processing apparatus 800. Program code, e.g., instructions, executed by the processor 830 may be stored in the memory 850.

The memory 850 may store the view-generation information received from the communication interface 810. The memory 850 may store executable instructions which are executed by the processor 830. The memory 850 may store a variety of information generated from processing by the processor 830. Also, the memory 850 may store a variety of data and programs/instructions. The memory 850 may include a volatile memory or a non-volatile memory (excluding signals per se). The memory 850 may include a large-capacity storage medium such as a hard disk to store a variety of data.

In addition, the processor 830 may perform at least one of the methods described in FIGS. 1 to 7 or a scheme which corresponds to at least one method. The processor 830 may be an image processing device implemented by hardware including a circuit having a physical structure to perform desired operations. For example, the desired operations may include code or instructions included in a program. For example, the hardware-implemented image processing apparatus 800 may include a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

The computing apparatuses, the electronic devices, the processors, the memories, the image sensors/cameras, the vehicle/operation function hardware, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A method comprising:
determining sample points sampled on a camera ray, wherein the camera ray is based on view-generation information comprising a scene viewing-position and a scene-viewing direction;
determining location statuses of the respective sample points based on a virtual cylindrical coordinate system defined by a center and a radius;
projecting and rendering a value of a pixel corresponding to the camera ray by, according the location statuses, applying the view-generation information to a first neural network to generate a first rendering result and to a second neural network to generate a second rendering result, wherein the first neural network has been trained to generate foreground images and the second neural network has been trained to generate background images; and
generating a rendered image based on blending the first rendering result and the second rendering result.

2. The method of claim 1, wherein the determining of the location statuses of the respective sample points comprises:
computing distances between the center and each of the plurality of points, respectively, and comparing the distances with the radius; and
determining whether the location status of a corresponding sample point among the plurality of sample points is foreground or background based on the comparing.

3. The method of claim 2, wherein the determining of whether the location status of a corresponding sample point is foreground or background based on the comparing comprises:
determining the location status of a corresponding sample point as foreground based on the corresponding distance being smaller than the radius; and
determining the location of a corresponding sample point as background based on the corresponding distance being greater than or equal to the radius.

4. The method of claim 3, wherein the rendering comprises:
applying the view-generation information to the first neural network in response to a location status of a corresponding sample point being determined to be foreground.

5. The method of claim 3, wherein the rendering comprises:
based on a location status of a corresponding sample point being determined to be background, changing the view-generation information to comprise the inverse of the radius; and
applying the changed view-generation information to the second neural network.

6. The method of claim 3, wherein the first neural network comprises:
a neural network trained to output a color and volume density of a pixel associated with a corresponding point in a foreground image based on receiving the view-generation information encoded based on the virtual cylindrical coordinate system.

7. The method of claim 3, wherein the second neural network comprises:
a neural network trained to output a color and volume density of a pixel associated with a corresponding point in a background image based on receiving the changed view-generation information encoded based on the virtual cylindrical coordinate system.

8. The method of claim 1, wherein the rendering comprises projecting and rendering a color and volume density of a pixel decided for each location status of the respective sample points.

9. A method comprising:
estimating pose information corresponding to at least one object included in each of respective image frames of an input image captured by a 360-degree camera;
encoding location statuses of respective points sampled for each of camera rays formed based on the pose information, based on a virtual cylindrical coordinate system defined by a center and a radius;
adding and rendering pixel values obtained by determining which of a first neural network or a second neural network to apply the encoded points to based on the location statuses, wherein the first neural network is configured to generate a foreground image and the second neural network is configured to generate a background image; and
training the first neural network and the second neural network based on a pixel value of a camera ray, the pixel value obtained by blending the rendering result for each of the camera rays.

10. The method of claim 9, wherein the encoding comprises:
estimating first pose information corresponding to at least a first object and a second object included in each of the image frames;
separating and encoding points corresponding to the first object as foreground based on a direction from which the 360-degree camera views the first object being inside a virtual cylinder corresponding to the virtual cylindrical coordinate system, and separating and encoding points corresponding to the second object as background based on being outside the virtual cylinder, based on the virtual cylindrical coordinate system.

11. The method of claim 10, wherein the encoding comprises:
determining the location statuses of the of respective points sampled for each of the camera rays as either foreground or background, based on the virtual cylindrical coordinate system; and
based on the determining of the location statuses, encoding each location status of the respective points.

12. The method of claim 11, wherein the determining the location statuses of the respective points as foreground or background comprises:
for each of the camera rays, computing distances between the center and the respectively corresponding points, and comparing the distances with the radius; and
for each of the camera rays, determining the location statuses of the respectively corresponding points as foreground or background based on results of the comparing.

13. The method of claim 12, wherein the determining of the location statuses of the points as foreground or background comprises:
determining the location status of a corresponding point as foreground based on the corresponding distance being less than the radius; and
determining the location status of a corresponding point as background based on the corresponding distance being greater than or equal to the radius.

14. The method of claim 13, wherein the rendering comprises at least one of:
first rendering by the first neural network according to the location status of a corresponding point being foreground; or
second rendering by the second neural network according to the location status of a corresponding point being background.

15. The training method of claim 14, wherein the training further comprises:
training the first neural network and the second neural network based on a difference between a pixel value generated by blending a result of the first rendering and a result of the second rendering.

16. A non-transitory computer-readable storage medium storing instructions that, when executed by a processor, cause the processor to perform the method of claim 9.

17. An apparatus comprising:
processing hardware;
storage hardware storing instructions configured to configure the processing hardware to:
sample points on a camera ray formed based on view-generation information comprising a position and direction of a view of a scene;
determine location statuses of the points based on a virtual cylindrical coordinate system defined by a center and a radius;
determine a pixel value by, for each point, according to the location status thereof, select between applying a first neural network trained to generate a foreground image and a second neural network trained to generate a background image; and
project and render the determined pixel value.

18. The apparatus of claim 17, further comprising rendering an image based on blending a result of applying the first neural network and the second neural network.

19. The apparatus of claim 17, wherein the instructions are further configured to configure the processing hardware to compare distances between the center and the respective points with the radius, and based thereon determine whether the location statuses of the points are foreground or background.

20. The apparatus of claim 19, wherein the instructions are further configured to configure the processing hardware to determine:
the location status of a corresponding point as foreground based the corresponding distance being less than the radius; and
the location status of a corresponding point as background based on the corresponding distance being greater than or equal to the radius.

21. The processing apparatus of claim 20, wherein the instructions are further configured to configure the processing hardware to apply and render the view-generation information to the first neural network based on the location status of a corresponding point being determined to be foreground, and apply and render the view-generation information, as changed to include the inverse of the radius, based on the location status of a corresponding point being determined to be background.

22. A method performed by a computing device, the method comprising:
projecting camera rays from a virtual camera pose to a scene to determine sample points of the respective camera rays;
according to a virtual cylinder and the virtual camera pose, determining first of the sample points as corresponding to a foreground of the scene and based thereon generating respective first pixel values of the scene by applying the virtual camera pose to a first neural network;
according to the virtual cylinder and the virtual camera pose, determining second of the sample points as corresponding to a background of the scene and based thereon generating respective second pixel values of the scene by applying a transform of the virtual camera pose to a second neural network; and
rendering an image of the scene by blending the first pixel values and the second pixel values.

23. The method of claim 22,
wherein determining that a first sample point of the first sample points corresponds to the foreground corresponds to determining that the first sample point is inside the virtual cylinder, and
wherein determining that a second sample point of the second sample points corresponds to the background corresponds to determining that the second sample point is outside the virtual cylinder.

24. The method of claim 22, wherein the transform is based on a radius of a virtual cylinder used to determine the first sample points as corresponding to the foreground and to determine the second sample points as corresponding to the background.

25. The method of claim 22, wherein the first neural network and the second neural network are trained by minimizing a loss function based on a 360-degree image.
